(19) United States
(12) Patent Application Publication
(10) Pub. No.: US 2009/0046396 A1
(43) Pub. Date: Feb. 19, 2009

(54) Magnetic Recording Medium, Linear Magnetic Recording and Reproduction System and Magnetic Recording and Reproduction Method

(75) Inventors: Takeshi Nagata, Kanagawa (JP); Hitoshi Noguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/295,569

(22) PCT Filed: Mar. 30, 2007
(86) PCT No.: PCT/JP2007/057300

§ 371 Date: Sep. 30, 2008

(30) Foreign Application Priority Data
Mar. 30, 2006 (JP) 2008-094807

(51) Int. Cl. G11B 5/33; G11B 5/74

(52) U.S. Cl. 360/324; 360/131; G9B/5.289; G9B/5.104

(57) ABSTRACT

The present invention relates to a magnetic recording medium comprising a magnetic layer comprising a ferromagnetic powder and a binder on a nomnagnetic support. A product, Mrδ, of a residual magnetization Mr of the magnetic layer and a thickness δ of the magnetic layer is equal to or greater than 2 mT•μm and equal to or less than 12 mT•μm, a squareness in a perpendicular direction is equal to or greater than 0.4 and equal to or less than 0.7, and a squareness in a longitudinal direction is equal to or greater than 0.3 but less than 0.6.

### CROSS-REFERENCE TO RELATED APPLICATIONS

This application claims the benefit of priority to Japanese Patent Application No. 2006-094807 filed on Mar. 30, 2006, which is expressly incorporated herein by reference in its entirety.

### TECHNICAL FIELD

The present invention relates to a magnetic recording medium, and more particularly, to a particulate magnetic recording medium capable of achieving a high S/N ratio even at narrow reproduction track widths without saturation of the giant magnetoresistive (GMR) elements in a linear magnetic recording and reproduction system employing a reproduction head in the form of a giant magnetoresistive magnetic head (GMR head). The present invention further relates to a linear magnetic recording and reproduction system and magnetic recording and reproduction method employing the above magnetic recording medium.

### BACKGROUND TECHNIQUE

In recent years, means for rapidly transmitting information at the terabyte level have undergone marked development. It has become possible to transmit data and images comprising huge amounts of information, while demand for advanced technology to record, reproduce, and store them has developed. Examples of recording and reproduction media include flexible disks, magnetic drums, hard disks, and magnetic tapes. Especially, the recording capacity of each reel of a magnetic tape is large, and such tapes play major roles, such as in data backup. For example, Japanese Unexamined Patent Publication (KOKAI) Heisei Nos. 3-280215 (“Reference 1” hereinafter, which is expressly incorporated herein by reference in its entirety) and 11-203652 (“Reference 2” hereinafter, which is expressly incorporated herein by reference in its entirety), Japanese Unexamined Patent Publication (KOKAI) No. 2002-74640 (“Reference 3” hereinafter, which is expressly incorporated herein by reference in its entirety), and Japanese Unexamined Patent Publication (KOKAI) Heisei No. 8-235570 (“Reference 4” hereinafter, which is expressly incorporated herein by reference in its entirety) disclose magnetic recording media in which the thickness of the magnetic layer, level of residual magnetization, or squareness is adjusted to handle higher recording densities.

In recent years, recording heads based on the operating principle of magnetoresistance (MR) have been proposed and the use thereof has begun. For example, Japanese Unexamined Patent Publication (KOKAI) No. 2001-23145 (“Reference 5” hereinafter, which is expressly incorporated herein by reference in its entirety) proposes a magnetic recording medium having a magnetic layer obtained by coating a magnetic coating material, in which the value Mrδ—the product of the residual magnetization, Mr, of the magnetic layer and the thickness, δ, of the magnetic layer—is 0.8 to 6.5 memu/cm² (10 to 82 mT•μm) for use in a helical scan magnetic recording system employing MR heads.

A high recording density is required to increase the recording capacity. Currently, to achieve higher recording densities, the trend is toward narrower track widths during recording and reproduction of magnetic recording media. Giant magnetoresitive reproduction heads (so-called “GMR heads”) of higher sensitivity have been proposed for the highly sensitive reproduction of signals recorded at high recording densities. Japanese Unexamined Patent Publication (KOKAI) No. 2001-23142 (“Reference 6” hereinafter, which is expressly incorporated herein by reference in its entirety) proposes a magnetic recording medium in which a metal magnetic thin film is formed on a nonmagnetic support, in which the Mrδ—the product of the residual magnetization Mr of the metal magnetic thin film and the thickness δ of the magnetic layer—is 0.5 to 1.5 memu/cm² (6.3 to 18.8 mT•μm) for use in a helical scan magnetic recording system employing MR heads.

When a highly sensitive GMR head is employed as the reproduction head, noise ends up being detected with high sensitivity. The narrower the reproduction track width becomes, the more the output tends to drop and noise tends to increase. Accordingly, in systems employing GMR heads with narrow track widths as reproduction heads, it is required to reduce noise from the medium side. When a GMR head saturates, signal distortion occurs and it becomes difficult to accurately reproduce the recorded signal. Thus, in systems employing GMR heads as reproduction heads, enhancing the S/N ratio requires: (i) reproducing the signal in a region in which the linearity of the MR resistance and the reproduction output is maintained to maintain signal linearity, and (ii) reducing medium noise.

As set forth above, References 5 and 6 propose the use of GMR heads as reproduction heads. However, although these techniques are suited to helical scan magnetic recording systems, there is a problem in that the desired S/N ratio cannot be achieved in linear magnetic recording and reproduction systems. In such systems, it is important to achieve an adequate S/N ratio in two running directions: forward recording and reproduction and reverse recording and reproduction. Above-cited References 1 to 4 do not disclose use of the magnetic recording media obtained in systems employing GMR heads as reproduction heads.

### DISCLOSURE OF THE INVENTION

Accordingly, it is an object of the present invention to provide a magnetic recording medium that is capable of maintaining a high S/N ratio even at narrow reproduction track widths, and more particularly, to provide a particulate magnetic recording medium capable of achieving a high S/N ratio without causing saturation of the GMR elements in a linear magnetic recording and reproduction system employing narrow track width GMR heads as recording heads.

The present inventors conducted extensive research into achieving the above-stated object.

First, the present inventors suppressed Mrδ, which is the product of the residual magnetization Mr of the magnetic layer and the thickness δ of the magnetic layer, to a lower level than in conventional magnetic recording media to prevent saturation of the GMR elements. However, when the thickness of the magnetic layer was reduced in order to lower Mrδ, the obtaining of an adequate S/N ratio in both running directions in linear magnetic recording and reproduction systems was found to be difficult with the magnetic characteristics achieved by conventional magnetic recording media.

The present inventors continued their research based on the above discoveries, discovering that the above-stated object was achieved by keeping the squareness in the perpendicular direction and the squareness in the longitudinal direction within prescribed ranges in a magnetic recording medium in which Mrδ was set at equal to or greater than 2 mT•μm and 12 mT•μm; the present invention was devised on that basis.

That is, the above-stated object was achieved by the following means:

[1] A magnetic recording medium comprising a magnetic layer comprising a ferromagnetic powder and a binder on a nonmagnetic support, wherein

a product, Mrδ, of a residual magnetization Mr of the magnetic layer and a thickness δ of the magnetic layer is equal to or greater than 2 mT•μm and equal to or less than 12 mT•μm,

a squareness in a perpendicular direction is equal to or greater than 0.4 and equal to or less than 0.7, and

a squareness in a longitudinal direction is equal to or greater than 0.3 but less than 0.6.

[2] The magnetic recording medium according to [1], wherein

the magnetic layer has a thickness of equal to or greater than 30 nm and equal to or less than 130 nm.

[3] The magnetic recording medium according to [1] or [2], wherein

the ferromagnetic powder is a hexagonal ferrite powder or an iron nitride powder.

[4] The magnetic recording medium according to any of [1] to [3], wherein

Mrδ is equal to or greater than 2 mT•μm and equal to or less than 8 mT•μm,

[5] The magnetic recording medium according to any of [1] to [4], which comprises a nonmagnetic layer comprising a nonmagnetic powder and a binder between the nonmagnetic support and the magnetic layer.
[6] The magnetic recording medium according to any of [1] to [5], which is employed in a linear magnetic recording and reproduction system employing a giant magnetoresistive magnetic head as a reproduction head.
[7] The magnetic recording medium according to [6], wherein

the giant magnetoresistive magnetic head has a reproduction track width ranging from 0.1 to 2.5 μm.

[8] A linear magnetic recording and reproduction system, comprising:

the magnetic recording medium according to any of [1] to [5], and

a reproduction head in the form of a giant magnetoresistive magnetic head.

[9] The linear magnetic recording and reproduction system according to [8], wherein

the giant magnetoresistive magnetic head has a reproduction track width ranging from 0.1 to 2.5 μm.

[10] A magnetic recording and reproduction method, in a linear magnetic recording and reproduction system, recording magnetic signals on the magnetic recording medium according to any of [1] to [5] and reproducing the signals with a giant magnetoresistive magnetic head.
[11] The magnetic recording and reproduction method according to [10], wherein

the giant magnetoresistive magnetic head has a reproduction track width ranging from 0.1 to 2.5 μm.

The magnetic recording medium of the present invention can achieve a high SIN ratio without causing saturation of the GMR elements in linear magnetic recording and reproduction systems employing narrow track width GMR heads as recording heads by keeping Mrδ—the product of the residual magnetization Mr of the magnetic layer and the thickness δ of the magnetic layer, the squareness in the perpendicular direction, and the squareness in the longitudinal direction within prescribed ranges.

### BEST MODE FOR CARRYING OUT THE INVENTION

### [Magnetic Recording Medium]

The magnetic recording medium of the present invention is a magnetic recording medium comprising a ferromagnetic powder and a binder on a nonmagnetic support, wherein a product, Mrδ, of a residual magnetization Mr of the magnetic layer and a thickness δ of the magnetic layer is equal to or greater than 2 mT•μm and equal to or less than 12 mT•μm, a squareness in a perpendicular direction is equal to or greater than 0.4 and equal to or less than 0.7, and a squareness in a longitudinal direction is equal to or greater than 0.3 but less than 0.6.

The magnetic recording medium of the present invention will be described in detail below.

In the magnetic recording medium of the present invention, Mrδ, the product of the residual magnetization Mr of the magnetic layer and the thickness δ of the magnetic layer, is equal to or greater than 2 mT•μm and equal to or less than 12 mT•μm. When Mrδis less than 2 mT•μm, even with the use of a GMR head, an adequate S/N ratio cannot be ensured when the track is narrow. When Mrδ is larger than 12 mT•μm, GMR heads saturate, asymmetry deteriorates, and it is difficult to achieve an adequate S/N ratio. Mrδ is desirably equal to or greater than 2 mT•μm and equal to or less than 8 mT•μm, preferably equal to or greater than 3 mT•μm and equal to or less than 7 mT•μm.

Mrδ can be controlled by means of the magnetic layer thickness (δ), the saturation magnetic flux density (Bm), and the squareness (SQ). The magnetic layer thickness (δ) is desirably equal to or greater than 30 nm and equal to or less than 130 um. When δ is equal to or greater than 30 nm, it is possible to prevent variation in the interface between the magnetic layer and the nonmagnetic layer from affecting media noise and deterioration of the S/N ratio. When δ is equal to or less than 130 nm, it is possible to avoid a reduction in reproduction efficiency by weakening of the leakage magnetic flux of the recorded signal from the magnetic layer. The magnetic layer is desirably 50 to 120 nm, preferably 60 to 100 nm, in thickness.

The saturation magnetic flux density (Bm) of the magnetic layer can be adjusted by means of the quantity of binder in the magnetic layer and the calendering conditions, and desirably ranges from 0.12 T to 0.18 T.

In the magnetic recording medium of the present invention, the squareness (SQ) in the perpendicular direction is equal to or greater than 0.4 or greater and equal to or less than 0.7 as well as the squareness (SQ) in the longitudinal direction is equal to or greater than 0.3 but less than 0.6. When SQ in the perpendicular direction is less than 0.4, the reproduction output at the high linear recording density required for high-density recording decreases and the S/N ratio drops. When SQ in the perpendicular direction exceeds 0.7, magnetic materials aggregate, media noise increases, and the S/N ratio drops. When employing a magnetic material in the form of ferromagnetic hexagonal ferrite, a tabular surface with an easy axis of magnetization faces the surface of the magnetic layer, compromising the running durability of the magnetic recording medium. When SQ in the longitudinal direction is less than 0.3, reproduction output drops, and at equal to or greater than 0.6, the magnetic materials aggregate and the media noise increases.

Conventional techniques emphasizing the squareness of a magnetic recording medium have involved an examination of controlling squareness in one direction. By contrast, research conducted by the present inventors has revealed that only when the perpendicular SQ and the longitudinal SQ fall within the above-stated respective ranges can an adequate S/N ratio be achieved in both the forward recording and reproduction and reverse recording and reproduction directions, which is important in linear magnetic recording systems.

Generally, the method of combining magnets in the longitudinal direction and magnets in the perpendicular direction is employed to adjust squareness in the perpendicular and longitudinal directions. However, as the thickness of the magnetic layer decreases to obtain an Mrδ of 2 to 12 mT•μm, depending on the shape of the magnetic material, it is sometimes difficult to achieve a perpendicular SQ and longitudinal SQ falling within the respective desired ranges by simply implementing the usual orientation processing in two directions. In such cases, it is desirable to enhance the dispersion of the magnetic layer to keep squareness in both directions within the desired ranges. Processing to increase dispersion will be described further below. In particular, due to the shape(hexagonal plate) of hexagonal ferrite powder, it becomes important to determine how to achieve orientation in the longitudinal direction as the magnetic layer is rendered thinner because of a tendency to face in the perpendicular direction. Thus, increasing the dispersion of the magnetic layer and employing hexagonal ferrite powder with an average plate ratio [average of (plate diameter/plate thickness)] ranging from 1 to 15 are desirable, and the use of such powder with an average plate ratio ranging from 1 to 7 is preferred. Hexagonal ferrite powder with a plate ratio falling within the above range makes it possible to achieve adequate orientation and keep the SQ values in the two directions within their respective desirable ranges while maintaining a high fill rate in the magnetic layer.

To reduce Mrδ by decreasing magnetic layer thickness δ, generally either (i) the quantity applied during coating is decreased or (ii) the liquid density is reduced. When the magnetic recording medium of the present invention is of a multilayered structure having a magnetic layer and a nonmagnetic layer, either a wet-on-dry coating method (where the magnetic layer coating liquid is applied after drying the nonmagnetic layer) or a wet-on-wet coating method (where the magnetic layer coating liquid is applied while the nonmagnetic layer is still wet) can be employed. In the present invention, use of the wet-on-dry method is desirable from the perspective of inhibiting variation in the interface between the magnetic layer and the nonmagnetic layer to reduce noise. In the use of the wet-on-wet method, when the thickness of the magnetic layer is reduced, magnetic material that dries quickly during drying in (i) aggregates, and when the concentration of the liquid is lowered by increasing the amount of solvent in (ii), the liquid itself loses dispersion stability and the drying period increases, tending to result in aggregation. That is, when the thickness δ of the magnetic layer is decreased to lower Mrδ, a problem in the form of reaggregation occurs during drying; it is thus difficult to achieve both a reduction in Mrδ and enhanced magnetic layer dispersion (an improvement in reaggregation).

In contrast, the present inventors conducted research revealing that controlling the particle size distribution of the magnetic particles in the magnetic layer made it possible to control reaggregation during drying. This was attributed to the fact that when a large quantity of undispersed powder material of relatively large particle diameter was present among the magnetic particles, these large particles served as nuclei for reaggregation. Accordingly, it was desirable to conducting processing to render the particle size distribution of the magnetic particles in the coating liquid uniform prior to coating, and remove particles serving as nuclei for reaggregation following drying. Specifically, in the case of hexagonal ferrite, the particle size distribution of the magnetic particles is desirably controlled so that the hexagonal ferrite powder contained in the magnetic layer has a particle size distribution such that the diameter of particles constituting 95 percent of the cumulative volume (referred to as “D95” hereinafter) is equal to or less than 70 nm (preferably equal to or less than 65 nm, more preferably falling within a range of 10 to 60 nm). In the case of iron nitride powder, the particle size distribution of the magnetic particles is desirably controlled so that the iron nitride powder contained in the magnetic layer has a particle size distribution such that D95 is equal to or less than 80 nm (preferably equal to or less than 75 nm, more preferably falling within a range of 5 to 70 nm).

An effective way to control the particle size distribution is to disperse the magnetic layer coating liquid in a sand mill using zirconia beads and conduct a grading process following kneading of the magnetic layer coating liquid in an open kneader. The grading process may be conducted with a centrifugal separator.

The magnetic recording medium of the present invention will be described in more detail below.

### Nonmagnetic Support

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazole can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127 can be employed to vary the surface roughness of the magnetic surface and the nonmagnetic support surface. The content of the above publication is expressly incorporated herein by reference in its entirety. These supports can be corona discharge treated, plasma treated, treated to facilitate adhesion, heat treated, treated to remove dust, or the like in advance. An aluminum or glass substrate can also be employed as the support.

Of these, a polyester support (referred to simply as “polyester” hereinafter) is desirable. The polyester is desirably comprised of dicarboxylic acid and a diol, such as polyethylene terephthalate and polyethylene naphthalate.

Examples of the dicarboxylic acid component serving as the main structural component are: terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindane dicarboxylic acid.

Examples of the diol component are: ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Among polyesters employing these compounds as main structural components, those comprising main structural components in the form of a dicarboxylic acid component in the form of terephthalic acid and/or 2,6-naphthalene dicarboxylic acid, and a diol component in the form of ethylene glycol and/or 1,4-cyclohexane dimethanol, are desirable from the perspectives of transparency, mechanical strength, dimensional stability, and the like.

Among these, polyesters comprising main structural components in the form of polyethylene terephthalate or polethylene-2,6-naphthalate; copolymer polyesters comprised of terephthalic acid, 2,6-naphthalene dicarboxylic acid, and ethylene glycol; and polyesters comprising main structural components in the form of mixtures of two or more of these polyesters are preferred. Polyesters comprising polyethylene-2,6-naphthalate as the main structural component are of even greater preference.

The polyester may be biaxially oriented, and may be a laminate with two or more layers.

Other copolymer components may be copolymerized and other polyesters may be mixed into the polyester. Examples are the dicarboxylic acid components and diol components given above by way of example, and polyesters comprised of them.

To help prevent delamination when used in films, aromatic dicarboxylic acids having sulfonate groups or ester-forming derivatives thereof, dicarboxylic acids having polyoxyalkylene groups or ester-forming derivatives thereof, diols having polyoxyalkylene groups, or the like can be copolymerized in the polyester.

Among these, 5-sodiumsulfoisophthalic acid, 2-sodiumsulfoterephthalic acid, 4-sodiumsulfophthalic acid, 4-sodiumsulfo-2,6-naphthylene dicarboxylic acid, compounds in which the sodium in these compounds has been replaced with another metal (such as potassium or lithium), ammonium salt, phosphonium salt, or the like, ester-forming compounds thereof, polyethylene glycol, polytetramethylene glycol, polyethylene glycol-polypropylene glycol copolymers, compounds in which the two terminal hydroxy groups of these compounds have been oxidized or the like to form carboxyl groups, and the like are desirable from the perspectives of the polyester polymerization reaction and film transparency. The ratio of copolymerization to achieve this end is desirably 0.1 to 10 mol percent based on the dicarboxylic acid constituting the polyester.

Further, to increase heat resistance, a bisphenol compound or a compound having a naphthalene ring or cyclohexane ring can be copolymerized. The copolymerization ratio of these compounds is desirably 1 to 20 mol percent based on the dicarboxylic acid constituting the polyester.

The above polyesters can be manufactured according to conventional known polyester manufacturing methods. An example is the direct esterification method, in which the dicarboxylic acid component is directly esterification reacted with the diol component. It is also possible to employ a transesterification method in which a dialkyl ester is first employed as a dicarboxylic acid component to conduct a transesterification reaction with a diol component, and the product is then heated under reduced pressure to remove the excess diol component and conduct polymerization. In this process, transesterification catalysts and polymerization catalysts may be employed and heat-resistant stabilizers added as needed.

One or more of various additives such as anticoloring agents, oxidation inhibitors, crystal nucleus agents, slipping agents, stabilizers, antiblocking agents, UV absorbents, viscosity-regulating agents, defoaming transparency-promoting agents, antistatic agents, pH-regulating agents, dyes, pigments, and reaction-stopping agents can be added at any step during synthesis.

Filler can be added to the polyester. Examples of fillers are: inorganic powders such as spherical silica, colloidal silica, titanium oxide, and alumina, and organic fillers such as crosslinked polystyrene and silicone resin. Further, to render the supports highly rigid, these materials can be highly oriented, and surface layers of metals, semimetals, and oxides thereof can be provided.

The nonmagnetic support in the form of polyester is desirably 3 to 80 micrometers, preferably 3 to 50 micrometers, and more preferably, 3 to 10 micrometers in thickness. The center surface average roughness (Ra) of the support surface is desirably equal to or less than 6 nm, preferably equal to or less than 4 nm. Ra is a value that is measured with an HD2000 made by WYKO.

Further, the Young's modulus of the nonmagnetic support is desirably equal to or greater than 6.0 GPa, preferably equal to or greater than 7.0 GPa, in the longitudinal and width directions.

The magnetic recording medium of the present invention comprises a magnetic layer comprising a ferromagnetic powder and a binder on at least one surface of the nonmagnetic support. A nonmagnetic layer (lower layer) is desirably provided between the nonmagnetic support and the magnetic layer.

### Magnetic Layer

The ferromagnetic powder contained in the magnetic layer desirably has a volume of 1,000 to 20,000 nm³, preferably 2,000 to 8,000 nm³. The use of a ferromagnetic powder having a volume within the above-stated range can inhibit a reduction in magnetic characteristics due to thermal fluctuation effectively and yield a good C/N (S/N) ratio while maintaining low noise.

The volume of acicular powder can be calculated from the major axis length and the minor axis length when a round columnar shape is envisioned.

The volume of hexagonal ferrite powder can be calculated from the plate diameter and axial length (plate thickness) when a hexagonal columnar shape is envisioned.

The size of the magnetic material can be calculated by the following method.

First, a suitable quantity of the magnetic layer is peeled off. To 30 to 70 mg of the magnetic layer that has been peeled off is added n-butylamine, the mixture is sealed in a glass tube, and the glass tube is placed in a thermal decomposition device. The glass tube is then heated for about a day at 140° C. After cooling, the contents are recovered from the glass tube and centrifugally separated to separate the liquid from the solid component. The solid component that has been separated is cleaned with acetone to obtain a powder sample for TEM. The particles in this sample are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured and the measured values are averaged to obtain the average size.

Examples of the ferromagnetic powder contained in the magnetic layer are ferromagnetic metal powder, hexagonal ferrite powder, and iron nitride powder. Of these, hexagonal ferrite powder and iron nitride powder are desirable from the perspective of making it possible to achieve both a reduction in the size of the magnetic material and high coercivity.

### (ii) Ferromagnetic Hexagonal Ferrite Powder

Examples of ferromagnetic hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed. Desirable additional atoms and their contents are identical to those of the above-described ferromagnetic metal powder.

The particle size of the hexagonal ferrite powder desirably satisfies the above-specified volume. The average plate diameter is desirably 10 to 50 nm, preferably 15 to 40 nm, and more preferably, 20 to 30 nm.

The average plate ratio (average of (plate diameter/plate thickness)) is desirably 1 to 15, preferably 1 to 7. At an average plate ratio of 1 to 15, adequate orientation can be achieved while maintaining a high fill rate in the magnetic layer, and an increase in noise due to particle stacking can be inhibited. Further, the specific surface area (S_{BET}) by BET method is desirably equal to or higher than 40 m²/g, preferably 40 to 200 m²/g, and preferably, 60 to 100 m²/g, within the above particle size range.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, a/average size is 0.1 to 1.0. The particle producing reaction system can be rendered as uniform as possible and the particles produced can be subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 to 318.5 kA/m (1800 to 4,000 Oe) can normally be achieved. The coercivity (Hc) of the hexagonal ferrite powder preferably ranges from 159.2 to 238.9 kA/m (2,000 to 3,000 Oe), more preferably 191.0 to 214.9 kA/m (2,200 to 2,800 Oe).

The coercivity (Hc) can be controlled by particle size (plate diameter and plate thickness), the types and quantities of elements contained, substitution sites of the element, the particle producing reaction conditions, and the like.

The saturation magnetization (a,) of the hexagonal ferrite powder preferably ranges from 30 to 80 A•m²/kg (30 to 80 emu/g). The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the magnetic material, the particle surface of the magnetic material can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added normally range from 0.1 to 10 mass percent relative to the mass of the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 is normally selected. Moisture contained in the magnetic material also affects dispersion. There is an optimum level for the dispersion medium and polymer, usually selected from the range of 0.01 to 2.0 percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity is set to, for example, 0.1 to 10 mass percent of the ferromagnetic powder. When applying a surface treatment, the quantity of a lubricant such as a fatty acid that is adsorbed is desirably not greater than 100 mg/m². The ferromagnetic powder will sometimes contain inorganic ions such as soluble Na, Ca, Fe, Ni, or Sr. These are desirably substantially not present, but seldom affect characteristics at equal to or less than 200 ppm.

### (ii) Iron Nitride Powder

In the present invention, the term “iron nitride powder” means magnetic powder containing at least an Fe₁₆N₂ phase. Iron nitride phases other than the Fe₁₆N₂ phase are not desirably present. This is because, although the crystal magnetic anisotropy of iron nitride (Fe₄N and Fe₃N phases) is about 1×10⁵ erg/cc (1×10⁻² J/cc), Fe₁₆N₂ has a high crystal magnetic anisotropy of 2×10⁶ to 7×10⁶ erg/cc (2×10⁻¹ to 7×10⁻¹ J/cc). Thus, high coercivity can be maintained even with microparticles. This high crystal magnetic anisotropy is due to the crystalline structure of the Fe₁₆N₂ phase. The crystalline structure is a body-centered square crystal with N atoms inserted at regular positions within an octahedral lattice of Fe. The distortion caused by the introduction of N atoms into the lattice is thought to be the causative factor behind the high crystal magnetic anisotropy. The easy axis of magnetization of the Fe₁₆N₂ phase is the C axis extended due to conversion to a nitride.

The shape of the particles containing the Fe₁₆N₂ phase is desirably granular or elliptic. Spherical is preferred. This is because, of the three equivalent directions of α-Fe, which is a cubic crystal, one is selected by conversion to a nitride to serve as the c axis (easy axis of magnetization). If the particle shape were to be acicular, the easy axis of magnetization would be the short axis direction, with particles in the major axis direction being undesirably mixed in. Accordingly, the average value of the aspect ratio of the major axis length/minor axis length is equal to or less than 2 (1 to 2, for example), preferably equal to or less than 1.5 (1 to 1.5, for example).

Generally, the particle diameter is determined by the diameter of the iron particle prior to conversion to a nitride, and is preferably a monodispersion. This is because, in general, medium noise drops in a monodispersion. The particle diameter of the iron nitride magnetic powder having Fe₁₆N₂ as main phase is normally determined by the particle diameter of the iron particles. The particle diameter distribution of the iron particles is desirably a monodispersion. This is because the nitride ratio differs in large particles and small particles, and the magnetic characteristics differ. For this reason as well, the particle diameter distribution of iron nitride magnetic powder is desirably a monodispersion.

The average particle diameter of the iron nitride is desirably 5 to 30 nm, preferably 5 to 25 nm, more preferably, 8 to 15 nm, and still more preferably, 9 to 11 nm. This is because a small particle diameter results in a large thermal fluctuation effect, causing super paramagnetism that is unsuited to a magnetic recording medium. Due to magnetic viscosity, the coercivity increases during high-speed recording in the head, making it hard to record. On the other hand, when the particle diameter increases, it becomes impossible to decrease the saturation magnetization, causing the coercivity to become excessively high during recording and making it difficult to record. When the particles are large, noise due to particles increases when employed in a magnetic recording medium. The average particle diameter of the iron nitride in the present invention refers to the average particle diameter of the Fe₁₆N₂ phase. When a layer is formed on the surface of Fe₁₆N₂ particles, it refers to the average size of the Fe₁₆N₂ particles without the layer. A layer such as an oxidation inhibiting layer can be optionally formed on the surface of the Fe₁₆N₂ particles.

The particle diameter distribution of the iron nitride is desirably a monodispersion. This is because medium noise generally decreases in a monodispersion. The coefficient of variation of the particle diameter is equal to or less than 15 percent (desirably 2 to 15 percent), preferably equal to or less than 10 percent (desirably 2 to 10 percent). The particle diameter and the coefficient of variation of the particle diameter can be calculated by placing and drying diluted alloy nanoparticles on a Cu 200 mesh on which a carbon film has been adhered, shooting a negative at 100,000-fold magnification by TEM (1200EX made by JEOL), measuring the negative with a particle diameter measuring device (KS-300 made by Carl Zeiss), and calculating the values from the arithmetic average particle diameter measured.

The content of nitrogen relative to iron in the particles contained in the Fe₁₆N₂ phase is desirably 1.0 to 20.0 atomic percent, preferably 5.0 to 18.0 atomic percent, and more preferably, 8.0 to 15.0 atomic percent. This is because when the amount of nitrogen becomes excessively low, the quantity of Fe₁₆N₂ phase that forms decreases. An increase in coercivity is caused by the distortion due to conversion to a nitride. When the quantity of nitrogen becomes excessively low, coercivity decreases. When too much nitrogen is present, the Fe₁₆N₂ phase becomes a semistable phase, becoming other nitrides that are stable phases when decomposed. As a result, the saturation magnetization decreases excessively.

In the present invention, the term “coefficient of variation of the particle diameter” means the value that is obtained by calculating the standard deviation of the particle diameter distribution for the equivalent circular diameter, and dividing it by the average particle diameter. The term “coefficient of variation of the composition” means the value that is obtained by calculating the standard deviation of the composition distribution of alloy nanoparticles in the same manner as for the coefficient of variation of the particle diameter, and dividing it by the average composition. Such values are multiplied by 100 and indicated as percentages in the present invention.

The average particle diameter and the coefficient of variation in the particle diameter can be calculated by placing and drying diluted alloy nanoparticles on a Cu 200 mesh on which a carbon film has been adhered, shooting a negative at 100,000-fold magnification by TEM (1200EX made by JEOL), measuring the negative with a particle diameter measuring device (KS-300 made by Carl Zeiss), and calculating the values from the arithmetic average particle diameter measured.

The surface of the iron nitride powder comprising the main phase of the Fe₁₆N₂ is desirably covered with an oxide film. This is because Fe₁₆N₂ microparticles oxidize readily and require handling in a nitrogen atmosphere.

The oxide film desirably contains rare earth elements and/or elements selected from among silicon and aluminum. Thus, the same particle surface as the conventional metal particles with main components in the form of iron and Co is present, with high compatibility with the steps for handling metal particles. Y, La, Ce, Pr, Nd, Sm, Th, Dy, and Gd are desirably employed as the rare earth elements, with the use of Y being preferred from the perspective of dispersibility.

Further, in addition to silicon and aluminum, boron and phosphorus can be incorporated as needed. Further, carbon, calcium, magnesium, zirconium, barium, strontium, and the like can be incorporated as effective elements. The use of these other elements with rare earth elements and/or silicon and aluminum can result in better shape retention and dispersion.

In the composition of the surface compound layer, the total content of rare earth elements or boron, silicon, aluminum or phosphorus relative to iron is desirably 0.1 to 40.0 atomic percent, preferably 1.0 to 30.0 atomic percent, and more preferably, 3.0 to 25.0 atomic percent. When the quantity of these elements is excessively low, formation of the surface compound layer becomes difficult. Not only does the magnetic anisotropy of the magnetic powder decrease, but oxidation stabilization tends to deteriorate. When the quantity of these elements is excessively high, the saturation magnetization tends to drop excessively.

The oxide film is desirably 1 to 5 nm, preferably 2 to 3 nm, in thickness. When it falls below this range, oxidation stabilization tends to decrease. When too thick, the particle size sometimes tends not to substantially decrease.

As a magnetic characteristic of the iron nitride powder comprising the main phase of Fe₁₆N₂, the coercivity (Hc) is desirably 79.6 to 318.4 kA/m (1,000 to 4,000 Oe), preferably 159.2 to 278.6 kA/m (2,000 to 3,500 Oe), and more preferably, 197.5 to 237 kA/m (2,500 to 3,000 Oe). This is because when the Hc is low, in the case of in-plane recording, for example, a given bit tends to be affected by bits recorded adjacent to it, sometimes compromising suitability to high recording density. When too high, recording becomes difficult.

The “Ms•V” of the iron nitride powder is desirably 5.2×10⁻¹⁶ to 6.5×10⁻¹⁶. The saturation magnetization Ms in the “Ms•V” can be measured using a vibrating magnetic measuring apparatus (VSM), for example. The volume V can be calculated by observing the particles by a transmission electron microscope (TEM), calculating the particle diameter of the Fe₁₆N₂ phase, and converting it to a volume.

The saturation magnetization of the iron nitride powder is desirably 80 to 160 Am²/kg (80 to 160 emu/g), preferably 80 to 120 Am²/kg (80 to 120 emu/g). This is because when too low, the signal sometimes becomes excessively weak, and when too high, in the case of in-plane recording, for example, a given bit tends to affect the bits recorded adjacent to it, compromising suitability to high recording density. A squareness of 0.6 to 0.9 is desirable.

In the iron nitride powder, the BET specific surface area is desirably 40 to 100 m²/g. This is because when the BET specific surface area is excessively low, the particle size increases, noise due to particles increases when applied to the magnetic recording medium, the surface smoothness of the magnetic layer decreases, and reproduction output tends to drop. When the BET specific surface area is excessively high, the particles comprising the Fe₁₆N₂ phase tend to aggregate, it becomes difficult to obtain a uniform dispersion, and it becomes difficult to obtain a smooth surface.

Iron nitride suitable for use in the present invention can be synthesized by known methods, and may be obtained as a commercial product. Reference can be made to Japanese Unexamined Patent Publication (KOKAI) No. 2007-36183 or the like for details on iron nitride suitable for use in the present invention. The content of the above publication is expressly incorporated herein by reference in its entirety.

(iii) Ferromagnetic Metal Powder

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 0.01 μm and equal to or less than 0.15 μm, more preferably equal to or greater than 0.02 μm and equal to or less than 0.15 μm, and still more preferably, equal to or greater than 0.03 μm and equal to or less than 0.12 μm. The acicular ratio of the ferromagnetic metal powder is preferably equal to or greater than 3 and equal to or less than 15, more preferably equal to or greater than 5 and equal to or less than 12. The as of the ferromagnetic metal powder is preferably 100 to 180 A•m²/kg, more preferably 110 to 170 A•m²/kg, and still more preferably, 125 to 160 A•m²/kg. The coercivity of the ferromagnetic metal powder is preferably 2,000 to 3,500 Oe (160 to 280 kA/m), more preferably 2,200 to 3,000 Oe (176 to 240 kA/m).

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. The SFD of the ferromagnetic metal powder itself is desirably low, with equal to or less than 0.8 being preferred. The Hc distribution of the ferromagnetic metal powder is desirably kept low. When the SFD is equal to or lower than 0.8, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

### Binder

Known techniques regarding binders, lubricants, dispersion agents, additives, solvents, dispersion methods and the like for the magnetic layer and nonmagnetic layer can be suitably applied to the magnetic layer and the nonmagnetic layer in the present invention. In particular, known techniques for the magnetic layer regarding the quantity and types of binders, and quantity added and types of additives and dispersion agents can be applied.

Conventionally known thermoplastic resins, thermosetting resins, reactive resins, and mixtures of the same can be employed as the binder. A thermoplastic resin having a glass transition temperature of −100 to 150° C., a number average molecular weight of 1,000 to 200,000, desirably 10,000 to 100,000, and a degree of polymerization of about 50 to 1,000 can be employed.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins in each layer. Examples and manufacturing methods of such resins are described in Japanese Unexamined Patent Publication (KOKAI) Showa No. 62-256219. The contents of the above publications are expressly incorporated herein by reference in their entirety. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Polyurethane resins may be employed, such as those having a known structure such as a polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from, for example, 10⁻¹ to 10⁻⁸ mol/g, preferably from 10⁻² to 10⁻⁶ mol/g.

Specific examples of the binders are VAGH, VYHH, VMCH, VAGF, VAGD, VROH, VYES, VYNC, VMCC, XYHL, XYSG, PKHH, PKHJ, PKHC, and PKFE from Dow Chemical Company, MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder employed in the magnetic layer and the nonmagnetic layer ranges from, for example, 5 to 50 mass percent, preferably from 10 to 30 mass percent, relative to the nonmagnetic powder or magnetic powder. When employing vinyl chloride resin, the quantity added is preferably from 5 to 30 mass percent; when employing polyurethane resin, from 2 to 20 mass percent; and when employing polyisocyanate, from 2 to 20 mass percent. They are preferably employed in combination. However, for example, when head corrosion occurs due to the release of trace amounts of chlorine, polyurethane alone or just polyurethane and isocyanate may be employed. When polyurethane is employed, polyurethanes suitable for use are those having a glass transition temperature ranging from −50 to 150° C., preferably from 0 to 100° C.; a elongation at break preferably ranging from 100 to 2,000 percent; a stress at break ranging from 0.05 to 10 kg/mm² (0.49 to 98 MPa); and a yield point ranging from 0.05 to 10 kg/mm² (0.49 to 98 MPa).

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

Additives may be added to the magnetic layer as needed. Examples of such additives are: abrasives, lubricants, dispersing agents, dispersing adjuvants, antifingal agents, antistatic agents, oxidation inhibitors, solvents, and carbon black. Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, butyl stearate, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.).

The above-described lubricants, antistatic agents and the like need not be 100 percent pure and may contain impurities, such as isomers, unreacted material, by-products, decomposition products, and oxides in addition to the main components. These impurities are preferably comprised equal to or less than 30 mass percent, and more preferably equal to or less than 10 mass percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Armide P manufactured by Lion Corporation; Duomine TDO manufactured by Lion Corporation; BA-41G manufactured by Nisshin OilliO, Ltd.; and Profan 2012E, Newpole PE61 and lonet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of carbon black are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. When employing carbon black, the quantity preferably ranges from 0.1 to 30 mass percent with respect to the mass of the magnetic material. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association may be consulted for types of carbon black suitable for use in the magnetic layer of the present invention.

### Abrasive

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, silicon carbide titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed in the present invention may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle diameter and quantity of the abrasives added to the magnetic layer and nonmagnetic layer should be set to optimal values.

Known organic solvents can be used. Examples of the organic solvents are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane; these may be employed in any ratio.

These organic solvents need not be 100 percent pure and may contain impurities such as isomers, unreacted materials, by-products, decomposition products, oxides and moisture in addition to the main components. The content of these impurities is preferably equal to or less than 30 mass percent, more preferably equal to or less than 10 mass percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the upper layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 mass percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. The magnetic recording medium of the present invention can comprise a nonmagnetic layer comprising a nonmagnetic powder and a binder on the nomnagnetic support. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 rm to 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from 10 to 200 nm. Within a range of 5 nm to 500 nm, dispersion is good and a nonmagnetic layer with good surface roughness can be achieved; the above range is preferred.

The specific surface area of the nonmagnetic powder ranges from, for example, 1 to 150 m²/g, preferably from 20 to 120 m²/g, and more preferably from 50 to 100 m²/g. Within the specific surface area ranging from 1 to 150 m²/g, suitable surface roughness can be achieved and dispersion is possible with the desired quantity of binder; the above range is preferred. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 mass percent, preferably from 0.2 to 3 mass percent, and more preferably from 0.3 to 1.5 mass percent. A moisture content falling within a range of 0.1 to 5 mass percent is desirable because it can produce good dispersion and yield a stable coating viscosity following dispersion. An ignition loss of equal to or less than 20 mass percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Specific examples of nonmagnetic powders suitable for use in the nonmagnetic layer are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, T-600B, T-100F and T-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (245 to 588 MPa), desirably 30 to 50 kg/mm² (294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp. can be referred to for details. The light transmittance is generally standardized to an infrared absorbance at a wavelength of about 900 tn equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the coating liquid. The quantity of the carbon black is preferably within a range not exceeding 50 mass percent of the inorganic powder as well as not exceeding 40 percent of the total mass of the nonmagnetic layer. These carbon blacks may be used singly or in combination. For example, the Carbon Black Handbook compiled by the Carbon Black Association may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefm resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above publications are expressly incorporated herein by reference in their entirety.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer.

### Layer Structure

As for the thickness structure of the magnetic recording medium of the present invention, the thickness of the nonmagnetic support preferably ranges from 3 to 80 micrometers, more preferably from 3 to 50 micrometers, further preferably from 3 to 10 micrometers, as set forth above. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

As set forth above, the thickness of the magnetic layer preferably ranges from 30 to 150 nm, more preferably 50 to 120 nm, further preferably, 60 to 100 nm, and is preferably optimized based on the saturation magnetization of the head employed, the length of the head gap, and the recording signal band. The thickness variation in the magnetic layer is preferably within i 50 percent, more preferably within 130 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer is effective so long as it is substantially nonmagnetic in the magnetic recording medium of the present invention. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the noumagnetic layer of equal to or less than 10 mT, or a coercivity of equal to or less than 7.96 kA/m (100 Oe), it being preferable not to have a residual magnetic flux density or coercivity at all.

### Back Layer

A back layer is desirably provided on the opposite surface of the nonmagnetic support from the surface on which the magnetic layer is provided, in the magnetic recording medium of the present invention. The back layer desirably comprises carbon black and inorganic powder. The formula of the magnetic layer or nonmagnetic layer can be applied to the binder and various additives for the formation of the back layer. The back layer is preferably equal to or less than 0.9 micrometer, more preferably 0.1 to 0.7 micrometer, in thickness.

### Manufacturing Method

The process for manufacturing a coating liquid for forming a magnetic layer, a nonmagnetic layer or a back layer comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these publications are incorporated herein by reference in their entirety. Further, glass beads may be employed to disperse the magnetic layer, nonmagnetic layer or back layer coating liquid, with a dispersing medium with a high specific gravity such as zirconia beads, titania beads, and steel beads being suitable for use as the glass beads. The particle diameter and fill ratio of these dispersing media can be optimized for use. A known dispersing device may be employed.

In the steps of manufacturing the magnetic layer coating liquid, it is desirable to enhance dispersion by means of the dispersion conditions (type and quantity of bead and peripheral speed employed in dispersion and the dispersion time). As set forth above, to effectively inhibit reaggregation during drying, it is desirable to subject the magnetic layer coating liquid to a grading process prior to coating to break up coarse particles serving as nuclei of reaggregation during drying. Any of the following methods may be employed as the grading process in the present invention: natural sedimentation controlling the particle size distribution based on liquid concentration and time, and centrifugal sedimentation controlling the particle size distribution based on liquid concentration, the rotational speed of the centrifugal separator, or the processing time. Further, the nonmagnetic coating liquid is also desirably subjected to a grading process to suppress interface variation between the magnetic layer and the nonmagnetic layer.

In the method of manufacturing the magnetic recording medium, for example, the magnetic layer can be formed by coating a magnetic layer coating liquid to a prescribed film thickness on the surface of a nonmagnetic support while the nonmagnetic support is running. Multiple magnetic layer coating liquids can be successively or simultaneously coated in a multilayer coating, and the nonmagnetic layer coating liquid and the magnetic layer coating liquid can be successively or simultaneously applied in a multilayer coating. As set forth above, from the perspective of the suppression of interface variation between the magnetic layer and the nonmagnetic layer, successive multilayer coating (wet-on-dry) is preferably conducted. Coating machines suitable for use in coating the magnetic layer or nonmagnetic layer coating liquid are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard.

When it is a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

Enhancing dispersion of the magnetic material in the magnetic layer coating liquid is an effective way to control orientation of the magnetic material. Methods of enhancing dispersion include: (i) extending the dispersion retention period of the magnetic layer coating liquid, (ii) increasing the tip peripheral speed of the disperser, (iii) and employing small dispersion beads. Further, the above grading process is also highly effective for enhancing dispersion of the magnetic material.

The magnetic field applied by the orientation device to impart an orientation to the magnetic material in the highly dispersed magnetic layer coating liquid is desirably 0 to 1,000 mT, preferably 0 to 800 mT, and preferably 0 to 500 mT. Increasing the magnetic field applied induces aggregation of magnetic material, so the magnetic field applied is desirably kept as small as possible within the range yielding the desired squareness.

The drying conditions before and after application of the magnetic field are also important for maintaining the magnetic material in an oriented state following magnetic field application. The drying position of the coating can be controlled by controlling the temperature and flow rate of the drying air and the coating speed. The coating speed is desirably 20 to 1,000 m/min and the temperature of the drying air is desirably equal to or higher than 60° C. Suitable predrying can be conducted prior to entry into the magnet zone.

The coated stock material thus obtained can be normally temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the longitudinal direction carries over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above. Additionally, it is possible to control the calender roll temperature, calender roll speed, and calender roll tension. Taking into account the properties of a particulate medium, it is desirable to control the surface smoothness by means of the calender roll pressure and calender roll temperature. The calender roll pressure is reduced, or the calender roll temperature is lowered, to diminish the surface smoothness of the final product. Conversely, the calender roll pressure is increased or the calender roll temperature is raised to increase the surface smoothness of the final product.

Alternatively, the magnetic recording medium obtained following the calendering step can be thermally processed to promote thermal curing. Such thermal processing can be suitably determined based on the blending formula of the magnetic layer coating liquid, for example, at 35 to 100° C., desirably at 50 to 80° C. The thermal processing time is , for example,12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

It is desirable for the magnetic recording medium of the present invention to have extremely good smoothness in the form of a center surface average roughness of the magnetic layer surface (at a cutoff value of 0.25 mm) of 0.1 to 4 nm, preferably within a range of 1 to 3 nm. The calendering conditions to achieve this are as follows. The calender roll temperature ranges from 60 to 100° C., preferably ranges from 70 to 100° C., and more preferably ranges from 80 to 100° C. The pressure ranges from 100 to 500 kg/cm (98 to 490 kN/m), preferably ranges from 200 to 450 kg/cm (196 to 441 kN/m), and more preferably, ranges from 300 to 400 kg/cm (294 to 392 kN/m).

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Physical Properties

As set forth above, in the magnetic layer of the magnetic recording medium of the present invention, Mrδ—the product of the residual magnetization Mr of the magnetic layer and the thickness δ of the magnetic layer—is 2 to 14 mT•μm. The Mrδ is preferably 2 to 8 mT•mT•μm, and more preferably, 3 to 7 mT•mT•μm.

Further, in the magnetic layer of the magnetic recording medium of the present invention, the squareness (SQ) in the perpendicular direction is equal to or greater than 0.4 and equal to or less than 0.7 and the squareness (SQ) in the longitudinal direction is equal to or greater than 0.3 but less than 0.6. The SQ in the perpendicular direction is desirably equal to or greater than 0.4 and equal to or less than 0.6 and the SQ in the longitudinal direction is desirably equal to or greater than 3.0 and equal to or less than 0.5. The SQ in the perpendicular direction is preferably equal to or greater than 0.5 and equal to or less than 0.6 and the SQ in the longitudinal direction is preferably equal to or greater than 0.4 and equal to or less than 0.5.

When the ranges of Mrδ and the SQ values of the magnetic layer are not simultaneously satisfied, the S/N ratio deteriorates at narrow reproduction track widths and GMR elements saturate. The above values are the values following demagnetizing field correction.

The saturation magnetic flux density of the magnet layer in the magnetic recording medium of the present invention is preferably 100 to 400 mT. The coercivity (Hc) of the magnetic layer is preferably 143.2 to 318.3 kA/m (1,800 to 4,000 Oe), more preferably 159.2 to 278.5 kA/m (2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium of the present invention relative to the head is, for example, equal to or less than 0.50 and preferably equal to or less than 0.3 at temperatures ranging from −10° C. to 40° C. and humidity ranging from 0 percent to 95 percent, the surface resistivity on the magnetic surface preferably ranges from 104 to 108 ohm/sq, and the charge potential preferably ranges from −500 V to +500 V. The modulus of elasticity at 0.5 percent extension of the magnetic layer preferably ranges from 0.98 to 19.6 GPa (100 to 2,000 kg/mm²) in each in-plane direction. The breaking strength preferably ranges from 98 to 686 MPa (10 to 70 kg/mm²). The modulus of elasticity of the magnetic recording medium preferably ranges from 0.98 to 14.7 GPa (100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

As set forth above, in the magnetic recording medium of the present invention, keeping the perpendicular SQ and longitudinal SQ within the respective ranges set forth above makes it possible to achieve a good S/N ratio in the high-density recording region in both the forward and reverse directions in a linear magnetic recording system. Further, keeping Mrδ within a range of 2 to 12 mT•μm can prevent saturation of GMR heads while maintaining good output.

A linear magnetic recording system is a system in which signal recording and reproduction are conducted in parallel with the direction in which the medium runs, and in which bidirectional recording and reproduction are generally required. Typical examples of linear tape systems are the Linear Tape-Open (LTO) and Digital Linear Tape (DLT) systems.

The magnetic recording system of the present invention is suited to linear magnetic recording and reproduction systems in which signals that have been magnetically recorded at a maximum linear recording density of equal to or greater than 150 kfci (even 200 to 400 kfci) are reproduced with AMR heads or GMR heads, desirably GMR heads. By way of example, the distance between shields (sh-sh) is 0.08 to 0.18 micrometer, and the reproduction track width is 0.1 to 2.5 micrometers, desirably 0.1 to 1.5 micrometers. GMR heads exploit a magnetoresistive effect corresponding to the magnitude of the magnetic flux on a thin-film magnetic head, affording advantages such as attaining higher reproduction output levels than can be achieved with inductive heads. This is primarily because there is no dependence on the relative speed between the medium and the head, since the reproduction output of a GMR head is based on change in magnetoresistance. In particular, GMR heads permit about threefold improvement in reading sensitivity over AMR heads. The use of such a GMR head as the reproduction head permits the reproduction with high sensitivity of signals that have been recorded at high density.

When the magnetic recording medium of the present invention is in the form of a tape magnetic recording medium, the use of a GMR head as reproduction head permits reproduction at a high S/N ratio even when the signal has been recorded at a higher density than is conventionally the case. Accordingly, the magnetic recording medium of the present invention can be in the form of a magnetic tape such as a video tape or computer tape, can be in the form of a magnetic disk such as a flexible disk or hard disk, and is optimal as a magnetic recording medium in the form of a magnetic tape or disk for use in high-density recording of computer data.

### [Magnetic Signal Reproduction System, Magnetic Signal Reproduction Method]

The present invention further relates to a linear magnetic recording and reproduction system comprising the magnetic recording medium of the present invention and a reproduction head in the form of a giant magnetoresistive magnetic head, and to a magnetic recording and reproduction method, in a linear magnetic recording and reproduction system, recording magnetic signals on the magnetic recording medium of the present invention and reproducing the signals with a giant magnetoresistive magnetic head. Details of the magnetic recording medium, reproduction head and the like employed in the magnetic signal reproduction system and the magnetic signal reproduction method of the present invention are as set fort above.

As set forth above, the magnetic recording medium of the present invention can achieve excellent recording and reproduction characteristics in linear magnetic recording and reproduction systems recording signals in the high density recording region, and permit highly sensitive reading with GMR heads. The magnetic signal reproduction system and magnetic signal reproduction method of the present invention that employ such a magnetic recording medium can reproduce with a good S/N ratio a signal recorded at high density.

### EXAMPLES

The present invention will be described in greater detail below through Examples. The components, ratios, operations, sequences, and the like indicated here can be modified without departing from the spirit of the present invention, and are not to be construed as being limited to Examples set forth below. The “parts” given in Examples denote mass parts unless specifically indicated otherwise.

After kneading the various components, that are set forth below, of the magnetic layer coating liquid, nonmagnetic layer coating liquid, and back layer coating liquid in an open kneader, they were dispersed in a sand mill. The dispersions obtained were filtered with a filter having an average pore diameter of 1 micrometer to prepare a magnetic layer coating liquid, nonmagnetic layer coating liquid, and back layer coating liquid.

Magnetic layer coating liquid A

| | | |
|---|---|---|
| Ferromagnetic plate-shaped hexagonal ferrite powder | 100 | parts |
| (Composition other than oxygen (molar ratio): Ba/Fe/Co/Zn = 1/9/0.2/1, Hc: | | |
| 1820 Oe (145 kA/m), average plate diameter: 23 nm, plate ratio: 3.4, specific surface | | |
| area: 67.2 m²/g, σs: 49 A · m²/kg (49 emu/g)) | | |
| Vinyl chloride copolymer | 12 | parts |
| (—SO₃K = 100 eq/ton, degree of polymerization: 300) | | |
| Polyester polyurethane resin | 4 | parts |
| (Neopentylglycol/caprolactone polyol/MDI = 0.9/2.6/1, —SO₃Na = 100 eq/ton) | | |
| Phenylphosphonic acid | 3 | parts |
| α-alumina (average particle diameter: 0.15 micrometer) | 2 | parts |
| Carbon black (average particle diameter: 30 nm) | 5 | parts |
| Butyl stearate | 1 | part |
| Stearic acid | 2 | parts |
| Methyl ethyl ketone | 125 | parts |
| Cyclohexanone | 125 | parts |

Magnetic layer coating liquid B

| | | |
|---|---|---|
| Ferromagnetic plate-shaped hexagonal ferrite powder | 100 | parts |
| (Composition other than oxygen (molar ratio): Ba/Fe/Co/Zn = 1/9/0.2/1, Hc: | | |
| 2500 Oe (200 kA/m), average plate diameter: 20 nm, plate ratio: 3, σs: 55 A · m²/kg (55 | | |
| emu/g)) | | |
| Polyurethane resin based on branched side chain-comprising polyester | 15 | parts |
| polyol/diphenylmethane diisocyanate, —SO³Na = 400 eq/ton | | |
| Carbon black (average particle diameter: 80 nm) | 0.5 | part |
| Diamond powder (average particle diameter: 80 nm) | 3 | parts |
| Cyclohexanone | 150 | parts |
| Methyl ethyl ketone | 150 | parts |
| Butyl stearate | 1 | part |
| Stearic acid | 2 | parts |

Magnetic layer coating liquid C

| | | |
|---|---|---|
| Iron nitride magnetic powder (Fe₁₆N₂, average particle diameter: 15 nm) | 100 | parts |
| Hc: 15.9 kA/m (2000 Oe) | | |
| BET specific surface area: 63 m²/g | | |
| σs: 100 A · m²/kg (100 emu/g) | | |
| Vinyl chloride-hydroxypropyl acrylate copolymer resin | 8 | parts |
| (—SO₃Na group content: 0.7 × 10⁻⁴ eq/g) | | |
| Polyurethane resin based on branched side chain-comprising polyester | 25 | parts |
| polyol/diphenylmethane diisocyanate, —SO₃Na = 400 eq/ton | | |
| α-alumina (average particle diameter: 80 nm) | 5 | parts |
| Plate-shaped alumina powder (average particle diameter: 50 nm) | 1 | part |
| Diamond powder (average particle diameter: 80 nm) | 1 | part |
| Carbon black (average particle diameter: 25 nm) | 1.5 | parts |
| Myristic acid | 1.5 | parts |
| Methyl ethyl ketone | 133 | parts |
| Toluene | 100 | parts |
| Stearic acid | 1.5 | parts |
| Polyisocyanate (Coronate L made by Nippon Polyurethane Industry Co. Ltd.) | 4 | parts |
| Cyclohexanone | 133 | parts |
| Toluene | 33 | parts |

Nonmagnetic layer coating liquid

| | | |
|---|---|---|
| Nonmagnetic inorganic powder: α-iron oxide | 85 | parts |
| Average major axis length: 0.15 micrometer | | |
| Average acicular ratio: 7 | | |
| BET specific surface area: 52 m²/g | | |
| Surface treatment: Al₂O₃, SiO₂ | | |
| Tap density: 0.8, pH: 8 | | |
| Carbon black | 15 | parts |
| Average particle diameter: 20 nm | | |
| DBP oil absorption capacity: 120 mL/100 g | | |
| pH: 8 | | |
| BET specific surface area: 250 m²/g | | |
| Vinyl chloride copolymer | 13 | parts |
| (—SO₃K = 100 eq/ton, degree of polymerization: 300) | | |
| Polyurethane resin based on branched side chain-comprising polyester | 6 | parts |
| polyol/diphenylmethane diisocyanate, —SO₃Na = 120 eq/ton | | |
| Phenylphosphonic acid | 3 | parts |
| Cyclohexanone | 140 | parts |
| Methyl ethyl ketone | 170 | parts |
| Butyl stearate | 2 | parts |
| Stearic acid | 1 | part |

Back layer coating liquid

| | | |
|---|---|---|
| Nonmagnetic inorganic powder: α-iron oxide | 80 | parts |
| Average major axis length: 0.15 micrometer | | |
| Average acicular ratio: 7 | | |
| BET specific surface area: 52 m²/g | | |
| Carbon black | 20 | parts |
| Average particle diameter: 20 nm | | |
| Carbon black | 3 | parts |
| Average particle diameter: 100 nm | | |
| Vinyl chloride copolymer | 13 | parts |
| Sulfonic acid group-containing polyurethane resin | 6 | parts |
| Phenylphosphonic acid | 3 | parts |
| Cyclohexanone | 140 | parts |
| Methyl ethyl ketone | 170 | parts |
| Stearic acid | 3 | parts |

### (Preparation of Sample M1)

For magnetic layer coating liquid A above, magnetic material, carbon black, α-alumina, polyvinyl chloride, phenylphosphonic acid, and 50 mass percent of the quantity of the various solvents in the formula were kneaded for 60 minutes in an open kneader, after which the polyurethane resin and remaining components were added. Zirconia beads (1.0 mm) were then packed at a bead fill rate of 80 percent into a horizontal, circulating, pin-type sand mill disperser and the mixture was dispersed at a pin tip peripheral speed of 10 m/s to achieve a dispersion retention time of 30 minutes. To the dispersion obtained were added 14 parts of trifunctional low-molecular-weight polyisocyanate compound (Coronate 3041 made by Nippon Polyurethane Industry Co.) and 30 parts of cyclohexanone. The mixture was stirred for 20 minutes and then filtered with a filter having an average pore diameter of 0.5 micrometer to prepare a magnetic layer coating liquid.

For the nonmagnetic layer coating liquid above, the various components were kneaded in an open kneader for 60 minutes. Zirconia beads (1.0 mm) were then packed at a bead fill rate of 80 percent into a horizontal, circulating, pin-type sand mill disperser and the mixture was dispersed at a pin tip peripheral speed of 10 m/s to achieve a dispersion retention time of 30 minutes. To the dispersion obtained were added 6 parts of trifunctional low-molecular-weight polyisocyanate compound (Coronate 3041 made by Nippon Polyurethane Industry Co.) and 30 parts of cyclohexanone. The mixture was stirred for 20 minutes and then filtered with a filter having an average pore diameter of 0.5 micrometer to prepare a nonmagnetic layer coating liquid.

The nonmagnetic layer coating liquid was coated to a polyethylene terephthalate support 6 micrometers in thickness in a quantity calculated to yield a dry thickness of 1.5 micrometers, and dried. Thereover, magnetic layer coating liquid A was coated in a manner calculated to yield an Mrδ of 12.3 mT•μm, and while the magnetic layer was still wet, the medium was sequentially passed through orienting devices A and C to impart a longitudinal orientation. Orienting device A was comprised of homopolar magnets of opposite poles (surface magnetic flux density: 500 mT) and orienting device C as comprised of solenoid magnets (surface magnetic flux density: 500 mT). The magnetic layer coating liquid was dried to a degree at which the orientation would not revert within the solenoid magnets, and then fully dried. Subsequently, a back layer 0.5 micrometer in thickness was coated. The medium was wound, processed to impart surface smoothness with a calender comprised only of metal rolls at a speed of 100 m/min, a linear pressure of 300 kg/cm (294 kN/m), and a temperature of 90° C., and heat treated for 24 hours in a 70° C. dry environment. Following the heat treatment, the medium was slit into a ½ inch width. The surface of the magnetic layer was cleaned with a tape cleaning device by mounting it on a device equipped with slit product feeding and winding devices so that a nonwoven fabric and razor blade contacted with a magnetic surface, yielding a tape sample.

### (Preparation of Sample M2)

For magnetic layer coating liquid B above, the various components were kneaded for 60 minutes in an open kneader. Zirconia beads (0.5 mm) were then packed at a bead fill rate of 80 percent into a horizontal, circulating, pin-type sand mill disperser and the mixture was dispersed at a pin tip peripheral speed of 10 m/s to achieve a dispersion retention time of 60 minutes. To the dispersion obtained were added 6 parts of trifunctional low-molecular-weight polyisocyanate compound (Coronate 3041 made by Nippon Polyurethane Industry Co.) and 180 parts of cyclohexanone. The mixture was stirred for 20 minutes and then centrifugally separated under conditions indicated in the exhibit in a cooled centrifugal separator, the Himac CR-21D, made by Hitachi High Tech, to remove the aggregate, and then filtered with a filter having an average pore diameter of 0.5 micrometer to prepare a magnetic layer coating liquid.

For the above nonmagnetic layer coating liquid, the various components were kneaded for 60 minutes in an open kneader. Zirconia beads (1.0 mm) were then packed at a bead fill rate of 80 percent into a horizontal, circulating, pin-type sand mill disperser and the mixture was dispersed at a pin tip peripheral speed of 10 m/s to achieve a dispersion retention time of 30 minutes. To the dispersion obtained were added 6 parts of trifunctional low-molecular-weight polyisocyanate compound (Coronate 3041 made by Nippon Polyurethane Industry Co.). The mixture was stirred for 20 minutes and then filtered with a filter having an average pore diameter of 0.5 micrometer to prepare a nonmagnetic layer coating liquid.

The nonmagnetic layer coating liquid was coated to a polyethylene terephthalate support 6 micrometers in thickness in a quantity calculated to yield a dry thickness of 1.5 micrometers, and dried. Thereover, magnetic layer coating liquid B was coated in a manner calculated to yield an Mrδ of 4 mT•μm, and dried. Subsequently, a back layer was coated to a thickness of 0.5 micrometer. The medium was wound, processed to impart surface smoothness with a calender comprised only of metal rolls at a speed of 100 nm/min, a linear pressure of 300 kg/cm (294 kN/m), and a temperature of 90° C., and heat treated for 24 hours in a 70° C. dry environment. Following the heat treatment, the medium was slit into a ½ inch width. The surface of the magnetic layer was cleaned with a tape cleaning device by mounting it on a device equipped with slit product feeding and winding devices so that a nonwoven fabric and razor blade contacted with a magnetic surface, yielding a tape sample.

### (Preparation of Samples M3 to M16)

With the exception that the magnetic layer thickness and/or orientation conditions following coating of the magnetic layer were changed as shown in Table 1, samples M3 to M12 were prepared by the same method as sample M2. Orienting device A was comprised of homopolar magnets of opposite poles orienting in the longitudinal direction, orienting device B was comprised of opposing magnets of opposite poles orienting in the perpendicular direction, and orienting device C was comprised of solenoid magnets orienting in the longitudinal direction, with the orienting devices arranged in the stated order. The surface magnetic flux density of the individual magnets at the various levels was set to the conditions indicated in Table 1.

### (Preparation of Sample M17)

With the exception that the plate ratio of the ferromagnetic hexagonal ferrite powder employed was changed to 3.5, sample M17 was prepared by the same method as in sample M2.

### (Preparation of Sample M18)

With the exception that the plate ratio of the ferromagnetic hexagonal ferrite powder employed was changed to 3.5, sample M18 was prepared by the same method as in sample M14.

### (Preparation of Sample M19)

With the exception that the aggregate was not removed with a centrifugal separator in the preparation of the magnetic layer coating liquid, sample M19 was prepared by the same method as sample M2.

### (Preparation of Sample M20)

For magnetic layer coating liquid C above, the various components were kneaded for 60 minutes in an open kneader. Zirconia beads (0.5 mm) were then packed at a bead fill rate of 80 percent into a horizontal, circulating, pin-type sand mill disperser and the mixture was dispersed at a pin tip peripheral speed of 10 m/s to achieve a dispersion retention time of 60 minutes. To the dispersion obtained were added 6 parts of trifunctional low-molecular-weight polyisocyanate compound (Coronate 3041 made by Nippon Polyurethane Industry Co.) and 180 parts of cyclohexanone. The mixture was stirred for 20 minutes and then centrifugally separated under conditions indicated in the exhibit in a cooled centrifugal separator, the Himac CR-21D, made by Hitachi High Tech, to remove the aggregate, and then filtered with a filter having an average pore diameter of 0.5 micrometer to prepare a magnetic layer coating liquid.

For the above nonmagnetic layer coating liquid, the various components were kneaded for 60 minutes in an open kneader. Zirconia beads (1.0 mm) were then packed at a bead fill rate of 80 percent into a horizontal, circulating, pin-type sand mill disperser and the mixture was dispersed at a pin tip peripheral speed of 10 m/s to achieve a dispersion retention time of 30 minutes. To the dispersion obtained were added 6 parts of trifunctional low-molecular-weight polyisocyanate compound (Coronate 3041 made by Nippon Polyurethane Industry Co.). The mixture was stirred for 20 minutes and then filtered with a filter having an average pore diameter of 0.5 micrometer to prepare a nonmagnetic layer coating liquid.

The nonmagnetic layer coating liquid was coated to a polyethylene terephthalate support 6 micrometers in thickness in a quantity calculated to yield a dry thickness of 1.5 micrometers, and dried. Thereover, magnetic layer coating liquid B was coated in a manner calculated to yield an Mrδ of 4 mT•μm, and dried. Subsequently, a back layer was coated to a thickness of 0.5 micrometer. The medium was wound, processed to impart surface smoothness with a calender comprised only of metal rolls at a speed of 100 m/min, a linear pressure of 300 kg/cm (294 kN/m), and a temperature of 90° C., and heat treated for 24 hours in a 70° C. dry environment. Following the heat treatment, the medium was slit into a ½ inch width. The surface of the magnetic layer was cleaned with a tape cleaning device by mounting it on a device equipped with slit product feeding and winding devices so that a nonwoven fabric and razor blade contacted with a magnetic surface, yielding a tape sample.

### (Preparation of Samples M21 to M29)

With the exception that the magnetic layer thickness and/or orientation conditions following coating of the magnetic layer were changed as shown in Table 1, samples M21 to M29 were prepared by the same method as sample M20. Orienting device A was comprised of homopolar magnets of opposite poles orienting in the longitudinal direction, orienting device B was comprised of opposing magnets of opposite poles orienting in the perpendicular direction, and orienting device C was comprised of solenoid magnets orienting in the longitudinal direction, with the orienting devices arranged in the stated order. The surface magnetic flux density of the individual magnets at the various levels was set to the conditions indicated in Table 1.

### (Evaluation of the S/N Ratio of the Tape)

In a drum tester, ¼-inch tape was run at a relative speed of 2 m/s, a head was pressed down, and recording was conducted. The winding tension was 100 g.

An MIG head with a saturation magnetization of 1.3 T, a gap length of 0.2 micrometer, and a track width of 20 micrometers was employed as the recording head. The recording current was set to the optical recording current for each tape.

A reproduction head in the form of an AMR head with a track width of 6.0 micrometers and a distance between shields of 0.16 micrometer was employed in No. 1 of Table 1, and GMR heads with a track width of 1.5 micrometers and a distance between shields of 0.16 micrometers were employed for the remainder.

The S/N ratio was calculated for a signal S in the form of the output of a 7.875 MHz (200 kfci) recording and reproduction signal, and the integral noise N at 0 to 15.75 MHz (0 to 400 kfci), as a ratio of S to N. Within the integral range of integral noise N, calculations were made replacing the range of 0 to 1 MHz with the noise value of 1 MHz, and replacing the range of 7.375 to 8.375 MHz with the average values of the noise at 7.375 and 8.375 MHz.

The measurements were made with a FSEA30 spectrum analyzer made by Rohde & Schwarz with settings of: RBW: 100 kHz, VBW: 1 kHz, SWP: 700 ms, and AVE: 16 times.

### (Asymmetry Evaluation)

Isolated waves were recorded, the reproduction signal was captured with a digital oscilloscope, and the output ratio in the positive and negative directions was adopted as the asymmetry. The smaller the number, the less signal distortion there was, and the better the linearity of the MR resistivity or reproduction output was maintained. Asymmetry of equal to or less than 15 percent was accompanied by little signal distortion causing MR head saturation and good reproduction output.

### (Scratch Resistance of the Tape)

An alumina sphere 6.35 mm in diameter was pressed with a load of 20 g onto tape that had been mounted on a glass slide, and after being slid back and forth over a fixed path, the degree of damage sustained by the tape was observed by an optical microscope. An “X” was given when the magnetic layer had been destroyed, a “triangle” was given when the magnetic layer had sustained weak damage, and a “O” was given when no damage to the magnetic layer was observed.

### (Method of Measuring D95 of the Magnetic Layer Coating Liquid)

D95: 0.5 g of the upper layer magnetic coating liquid following grading was diluted with 49.5 mg of methyl ethyl ketone and the particle size distribution of the liquid was measured with a laser-scattering particle size distribution analyzer, the LB500, made by Horiba. The particle diameter was calculated at which 95 percent of the volume had accumulated when calculating the distribution of the ratio of each particle diameter present.

### (Method of Measuring Mrδ)

Measured at Hm 1194 kA/m (15 kOe) with a vibrating sample fluxmeter (made by Toei Industry Co.).

### [Table 1]

TABLE 1

| | | | | | Centrifugal separation | | | Magnetic | | |
|---|---|---|---|---|---|---|---|---|---|---|
| | | | Plate diameter of BaFe or | Plate | processing | | | layer | Orientation magnet | |
| | | Magnetic | particle diameter of | ratio of | Rotational | | D95 | thickness | Magnetic field of | Magnetic field of |
| No. | Media | material | Fe₁₆N₂(nm) | BaFe | speed (rpm) | Time (min) | (nm) | (nm) | magnet A (mT) | magnet B (mT) |
| 1 | M1 | BaFe | 23 | 3.4 | — | — | 95 | 140 | 500 | — |
| 2 | M1 | BaFe | 23 | 3.4 | — | — | 95 | 140 | 500 | |
| 3 | M2 | BaFe | 20 | 3 | 10000 | 30 | 65 | 70 | — | — |
| 4 | M3 | BaFe | 20 | 3 | 10000 | 30 | 65 | 70 | 500 | — |
| 5 | M4 | BaFe | 20 | 3 | 10000 | 30 | 65 | 70 | 500 | — |
| 6 | M5 | BaFe | 20 | 3 | 10000 | 30 | 65 | 70 | 500 | — |
| 7 | M6 | BaFe | 20 | 3 | 10000 | 30 | 65 | 70 | 500 | 500 |
| 8 | M7 | BaFe | 20 | 3 | 10000 | 30 | 65 | 70 | 500 | 500 |
| 9 | M8 | BaFe | 20 | 3 | 10000 | 30 | 65 | 70 | 500 | 500 |
| 10 | M9 | BaFe | 20 | 3 | 10000 | 30 | 65 | 70 | — | 800 |
| 11 | M10 | BaFe | 20 | 3 | 10000 | 30 | 65 | 70 | 500 | 300 |
| 12 | M11 | BaFe | 20 | 3 | 10000 | 30 | 65 | 100 | — | — |
| 13 | M12 | BaFe | 20 | 3 | 10000 | 30 | 65 | 130 | — | — |
| 14 | M13 | BaFe | 20 | 3 | 10000 | 30 | 65 | 150 | — | — |
| 15 | M14 | BaFe | 20 | 3 | 10000 | 30 | 65 | 40 | — | — |
| 16 | M15 | BaFe | 20 | 3 | 10000 | 30 | 65 | 30 | — | — |
| 17 | M16 | BaFe | 20 | 3 | 10000 | 30 | 65 | 230 | — | — |
| 18 | M17 | BaFe | 20 | 3.5 | 10000 | 30 | 70 | 70 | — | — |
| 19 | M18 | BaFe | 20 | 3.5 | 10000 | 30 | 70 | 40 | — | — |
| 20 | M19 | BaFe | 20 | 3 | — | — | 95 | 70 | — | — |
| 21 | M20 | Fe₁₆N₂ | 15 | — | 10000 | 30 | 70 | 70 | — | — |
| 22 | M21 | Fe₁₆N₂ | 15 | — | 10000 | 30 | 70 | 100 | — | — |
| 23 | M22 | Fe₁₆N₂ | 15 | — | 10000 | 30 | 70 | 100 | 500 | — |
| 24 | M23 | Fe₁₆N₂ | 15 | — | 10000 | 30 | 70 | 100 | 500 | — |
| 25 | M24 | Fe₁₆N₂ | 15 | — | 10000 | 30 | 70 | 100 | — | 300 |
| 26 | M25 | Fe₁₆N₂ | 15 | — | 10000 | 30 | 70 | 100 | — | 500 |
| 27 | M26 | Fe₁₆N₂ | 15 | — | 10000 | 30 | 70 | 100 | — | 800 |
| 28 | M27 | Fe₁₆N₂ | 15 | — | 10000 | 30 | 70 | 130 | — | — |
| 29 | M28 | Fe₁₆N₂ | 15 | — | 10000 | 30 | 70 | 25 | — | — |
| 30 | M29 | Fe₁₆N₂ | 15 | — | 10000 | 30 | 70 | 20 | — | — |

| | Orientation magnet | | | | | | | | | Scratch |
|---|---|---|---|---|---|---|---|---|---|---|
| | Magnetic field of | Mr δ | Perpendicular | Longitudinal | Head | Output | Noise | S/N ratio | Asymmetry | resistance of |
| No. | magnet C (mT) | (mT · μm) | SQ | SQ | employed | (dB) | (dB) | (dB) | (%) | media |
| 1 | 500 | 12.3 | 0.38 | 0.62 | A(AMR) | — | — | −3.0 | 2 | ∘ |
| 2 | 500 | 12.3 | 0.38 | 0.62 | B(GMR) | 0.0 | 0.0 | 0.0 | 18 | ∘ |
| 3 | — | 4 | 0.6 | 0.4 | B(GMR) | 4.0 | −3.0 | 7.0 | 2 | ∘ |
| 4 | — | 4 | 0.55 | 0.45 | B(GMR) | 3.5 | −3.0 | 6.5 | 2 | ∘ |
| 5 | 300 | 4 | 0.4 | 0.5 | B(GMR) | 3.0 | −2.5 | 5.5 | 2 | ∘ |
| 6 | 500 | 4 | 0.35 | 0.55 | B(GMR) | −1.0 | 0.0 | −1.0 | 2 | ∘ |
| 7 | 500 | 4 | 0.6 | 0.5 | B(GMR) | 4.5 | −2.5 | 7.0 | 2 | ∘ |
| 8 | 300 | 4 | 0.7 | 0.4 | B(GMR) | 5.0 | −1.5 | 6.5 | 2 | ∘ |
| 9 | — | 4 | 0.75 | 0.3 | B(GMR) | 4.0 | 4.0 | 0.0 | 2 | x |
| 10 | — | 4 | 0.7 | 0.25 | B(GMR) | 1.0 | 1.0 | 0.0 | 2 | ∘ |
| 11 | 800 | 4 | 0.55 | 0.6 | B(GMR) | 2.0 | 2.0 | 0.0 | 2 | ∘ |
| 12 | — | 6 | 0.55 | 0.45 | B(GMR) | 3.0 | −3.0 | 6.0 | 4 | ∘ |
| 13 | — | 8 | 0.55 | 0.45 | B(GMR) | 2.5 | −2.5 | 5.0 | 6 | ∘ |
| 14 | — | 10 | 0.55 | 0.45 | B(GMR) | 0.0 | −2.5 | 2.5 | 10 | ∘ |
| 15 | — | 2 | 0.62 | 0.38 | B(GMR) | 2.0 | −3.0 | 5.0 | 2 | ∘ |
| 16 | — | 1.5 | 0.65 | 0.35 | B(GMR) | −2.0 | −2.0 | 0.0 | 2 | ∘ |
| 17 | — | 14 | 0.55 | 0.45 | B(GMR) | 1.0 | 0.0 | 1.0 | 20 | ∘ |
| 18 | — | 4 | 0.65 | 0.4 | B(GMR) | 4.0 | −2.0 | 6.0 | 2 | ∘ |
| 19 | — | 2 | 0.72 | 0.35 | B(GMR) | 4.0 | 5.0 | −1.0 | 2 | x |
| 20 | — | 4 | 0.38 | 0.53 | B(GMR) | −1.0 | 1.0 | −2.0 | 2 | ∘ |
| 21 | — | 10 | 0.5 | 0.5 | B(GMR) | 5.0 | −1.0 | 6.0 | 10 | ∘ |
| 22 | — | 12 | 0.5 | 0.5 | B(GMR) | 5.0 | −1.0 | 6.0 | 12 | ∘ |
| 23 | — | 12 | 0.4 | 0.55 | B(GMR) | 4.5 | −1.0 | 5.5 | 12 | ∘ |
| 24 | 300 | 12 | 0.35 | 0.6 | B(GMR) | 0.0 | 2.0 | −2.0 | 12 | ∘ |
| 25 | — | 12 | 0.6 | 0.4 | B(GMR) | 5.0 | 0.0 | 5.0 | 12 | ∘ |
| 26 | — | 12 | 0.7 | 0.3 | B(GMR) | 5.0 | 1.0 | 4.0 | 12 | ∘ |
| 27 | — | 12 | 0.8 | 0.25 | B(GMR) | 4.5 | 5.0 | −0.5 | 12 | ∘ |
| 28 | — | 14 | 0.5 | 0.5 | B(GMR) | 4.5 | 4.0 | 0.5 | 20 | ∘ |
| 29 | — | 4 | 0.5 | 0.5 | B(GMR) | 4.0 | 1.0 | 3.0 | 2 | ∘ |
| 30 | — | 1.5 | 0.5 | 0.5 | B(GMR) | 1.0 | 2.0 | | 2 | ∘ |

### Evaluation Results

As shown in Table 1, good S/N ratios were obtained using a GMR head with a track width of 1.5 micrometers to reproduce signals recorded on tape samples in which Mrδ ranged from 2 to 12 mT•μm, the perpendicular squareness SQ ranged from 0.4 to 0.7, and the longitudinal SQ was equal to or greater than 0.3 but less than 0.6. The durability of the samples was also good (Nos. 3 to 5, 7, 8, 12 to 15, 18, 21 to 23, 25, 26, and 29 in Table 1). Further, asymmetry was low and good signal linearity was maintained in these samples.

The magnetic recording medium of the present invention is suitable for use as a magnetic recording medium for high-density recording.

1. A magnetic recording medium comprising a magnetic layer comprising a ferromagnetic powder and a binder on a nonmagnetic support, wherein
a product, Mrδ, of a residual magnetization Mr of the magnetic layer and a thickness δ of the magnetic layer is equal to or greater than 2 mT•μtm and equal to or less than 12 mT•μm,
a squareness in a perpendicular direction is equal to or greater than 0.4 and equal to or less than 0.7, and
a squareness in a longitudinal direction is equal to or greater than 0.3 but less than 0.6.

2. The magnetic recording medium according to claim 1, wherein
the magnetic layer has a thickness of equal to or greater than 30 nm and equal to or less than 130 nm.

3. The magnetic recording medium according to claim 1, wherein
the ferromagnetic powder is a hexagonal ferrite powder or an iron nitride powder.

4. The magnetic recording medium according to claim 1, wherein
Mrδ is equal to or greater than 2 mT•μm and equal to or less than 8 mT•μm.

5. The magnetic recording medium according to claim 1, which comprises a nonmagnetic layer comprising a nonmagnetic powder and a binder between the nonmagnetic support and the magnetic layer.

6. The magnetic recording medium according to claim 1, which is employed in a linear magnetic recording and reproduction system employing a giant magnetoresistive magnetic head as a reproduction head.

7. The magnetic recording medium according to claim 6, wherein
the giant magnetoresistive magnetic head has a reproduction track width ranging from 0.1 to 2.5 μm.

8. A linear magnetic recording and reproduction system, comprising:
the magnetic recording medium according to claim 1, and
a reproduction head in the form of a giant magnetoresistive magnetic head.

9. The linear magnetic recording and reproduction system according to claim 8, wherein
the giant magnetoresistive magnetic head has a reproduction track width ranging from 0.1 to 2.5 μm.

10. A magnetic recording and reproduction method, in a linear magnetic recording and reproduction system, recording magnetic signals on the magnetic recording medium according to claim 1 and reproducing the signals with a giant magnetoresistive magnetic head.

11. The magnetic recording and reproduction method according to claim 10, wherein
the giant magnetoresistive magnetic head has a reproduction track width ranging from 0.1 to 2.5 μm.
